(19) United States
(12) Patent Application Publication
(10) Pub. No.: US 2022/0379901 A1
(43) Pub. Date: Dec. 1, 2022

(54) MONITORING DEVICE, MONITORING METHOD, AND PROGRAM

(71) Applicant: MITSUBISHI HEAVY INDUSTRIES ENGINEERING, LTD., Kanagawa (JP)

(72) Inventors: Akihisa KAWAUCHI, Tokyo (JP); Hiroyuki KONO, Tokyo (JP); Koji UCHIDA, Tokyo (JP); Mitsuaki HOSHI, Yokohama-shi (JP)

(21) Appl. No.: 17/765,130

(22) PCT Filed: Jul. 28, 2020
(86) PCT No.: PCT/JP2020/028879

§ 371 Date: Mar. 30, 2022

(30) Foreign Application Priority Data
Oct. 21, 2019 (JP) 2019-191949

(51) Int. Cl. B60W 40/105; B60W 40/09

(52) U.S. Cl. CPC B60W 40/105; B60W 40/09; B60W 2040/0872

(57) ABSTRACT

This monitoring device comprises: an acceleration acquisition unit for acquiring acceleration data of a vehicle traveling along a track; an acceleration effective value acquisition unit for acquiring a plurality of acceleration effective values obtained by applying a bandpass filter for each of a plurality of constant specific bandwidths to the acceleration data; a corrected acceleration calculation unit for calculating a corrected acceleration on the basis of each of the acceleration effective values of the respective constant specific bandwidths and predetermined correction coefficients corresponding to the respective constant specific bandwidths; and an abnormality detection unit for detecting an abnormality of the vehicle or of the track on the basis of the magnitude of the corrected acceleration.

### TECHNICAL FIELD

The present disclosure relates to a monitoring device, a monitoring method, and a program.

### BACKGROUND ART

Patent Document 1 discloses a monitoring device that determines the presence or absence of an abnormal state of a vehicle based on acceleration of the vehicle or the like. The monitoring device described in Patent Document 1 determines the presence or absence of the abnormal state (vehicle derailment, vehicle or infrastructure malfunction, meandering, or the like) by applying a bandpass filter that passes a predetermined frequency band to a sensor signal output by an acceleration sensor installed in each vehicle, then further applying a window filter, obtaining root mean square values with a fixed time width, and relatively comparing the obtained root mean square values for each vehicle. According to the configuration described in Patent Document 1, it is possible to detect the abnormal state without using a threshold value condition subdivided according to an infrastructure state (track state, ground, climate, or the like) on which the vehicle travels, a traveling speed, or the like.

In addition, Non-Patent Document 1 is based on International Organization for Standardization (ISO) 2631-1: 1997, “Mechanical vibration and shock Evaluation of human exposure to whole-body vibration Part 1: General requirements”, is a Japanese Industrial Standard created without changing a technical content and a standard sheet format, and defines a measurement method of periodic, irregular, or transient whole body vibration. Non-Patent Document 1 shows a main factor leading to determination of whether or not human body exposure is acceptable. In Non-Patent Document 1, a corrected acceleration effective value subjected to frequency correction by using a correction coefficient defined for each 1/3 octave band is an evaluation target.

### CITATION LIST

### Patent Document

[Patent Document 1] Japanese Patent No. 6476287

### Non Patent Document

[Non Patent Document 1] Japanese Industrial Standards (JIS) B 7760-2: 2004, “Whole Body Vibration-Part 2: Basic Requirements for Measurement Methods and Evaluations”, established on Mar. 20, 2004

### SUMMARY OF INVENTION

### Technical Subject

In the monitoring device described in Patent Document 1, the state of the vehicle is monitored based on the frequency-corrected acceleration using one bandpass filter. Therefore, there is a subject that it may not be appropriate to determine whether or not abnormal vibration is generated for a person in the vehicle.

The present disclosure is made to solve the above subject, and a purpose of the present disclosure is to provide a monitoring device, a monitoring method, and a program capable of appropriately determining whether or not abnormal vibration is generated for a person in a vehicle.

### Subject to be Solved

In order to solve the above subject, a monitoring device according to the present disclosure includes an acceleration acquisition unit that acquires acceleration data of a vehicle traveling along a track, an acceleration effective value acquisition unit that acquires a plurality of acceleration effective values obtained by applying a bandpass filter for each of a plurality of constant ratio bandwidths to the acceleration data, a corrected acceleration calculation unit that calculates corrected acceleration based on each acceleration effective value of each of the constant ratio bandwidths and each correction coefficient determined in advance corresponding to each of the constant ratio bandwidths, and an abnormality detection unit that detects abnormality in the vehicle or the track based on magnitude of the corrected acceleration.

A monitoring method according to the present disclosure includes a step of acquiring acceleration data of a vehicle traveling along a track, a step of acquiring a plurality of acceleration effective values obtained by applying a bandpass filter for each of a plurality of constant ratio bandwidths to the acceleration data, a step of calculating corrected acceleration based on each acceleration effective value of each of the constant ratio bandwidths and each correction coefficient determined in advance corresponding to each of the constant ratio bandwidths, and a step of detecting abnormality in the vehicle or the track based on magnitude of the corrected acceleration.

A program according to the present disclosure causing a computer to execute a step of acquiring acceleration data of a vehicle traveling along a track, a step of acquiring a plurality of acceleration effective values obtained by applying a bandpass filter for each of a plurality of constant ratio bandwidths to the acceleration data, a step of calculating corrected acceleration based on each acceleration effective value of each of the constant ratio bandwidths and each correction coefficient determined in advance corresponding to each of the constant ratio bandwidths, and a step of detecting abnormality in the vehicle or the track based on magnitude of the corrected acceleration.

### Advantageous Effects of Invention

According to the monitoring device, the monitoring method, and the program of the present disclosure, it is possible to appropriately determine whether or not the abnormal vibration is generated for the person in the vehicle.

### BRIEF DESCRIPTION OF DRAWINGS

FIG. 1 is a side view schematically showing a configuration example of a monitoring device according to an embodiment of the present disclosure.

FIG. 2 is a block diagram showing a configuration example of a monitoring device 13 shown in FIG. 1.

FIG. 3 is a flowchart showing an operation example of the monitoring device 13 shown in FIG. 1.

FIG. 4 is a schematic diagram for describing the operation example of the monitoring device 13 shown in FIG. 1.

FIG. 5 is a schematic diagram for describing the operation example of the monitoring device 13 shown in FIG. 1.

FIG. 6 is a table showing basic correction coefficients described in Non-Patent Document 1.

FIG. 7 is a graph showing the basic correction coefficients described in Non-Patent Document 1.

FIG. 8 is a schematic block diagram showing a configuration of a computer according to at least one embodiment.

### DESCRIPTION OF EMBODIMENTS

### First Embodiment

(Configuration of Monitoring Device)

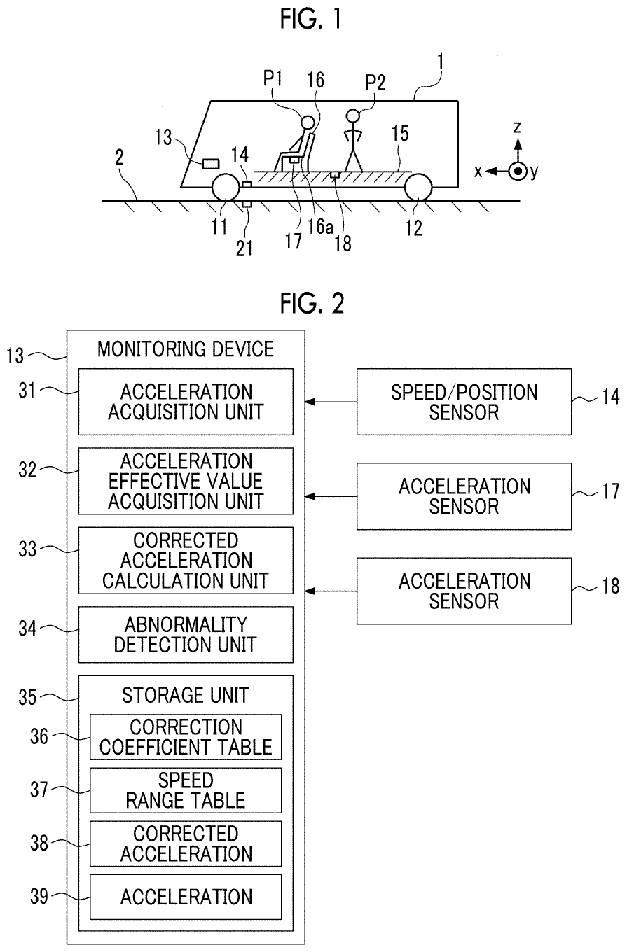

Hereinafter, a monitoring device according to an embodiment of the present disclosure will be described with reference to drawings. In each figure, the same reference numeral is used for the same or corresponding configuration, and description thereof will be omitted as appropriate. FIG. 1 is a side view schematically showing a configuration example of a monitoring device 13 according to a first embodiment of the present disclosure. FIG. 2 is a block diagram showing a configuration example of functional constituent elements included in the monitoring device 13 shown in FIG. 1. In the configuration example shown in FIG. 1, the monitoring device 13 is mounted on a vehicle 1 traveling along a track 2. However, a part or all of the configuration included in the monitoring device 13 may be provided outside the vehicle 1. In the present embodiment, the vehicle 1 is a vehicle for a rubber-tired new transportation system (automated guideway transit (AGT)) that travels on rubber tires 11 and 12 along a guideway (not shown) on a dedicated track 2 by autonomous driving. However, the monitoring device 13 is not limited thereto and can be generally applied to a vehicle that transports a passenger or a cargo by autonomous driving or manned driving. The vehicle 1 may be a train in which a plurality of vehicles 1 are connected. In that case, the monitoring device 13 can monitor acceleration detected by a plurality of acceleration sensors mounted on two or more vehicles 1, for example.

The vehicle 1 includes a floor 15 and a seat 16 installed on the floor 15. The vehicle 1 includes a speed/position sensor 14, an acceleration sensor 17, and an acceleration sensor 18.

The speed/position sensor 14 receives, for example, a predetermined signal transmitted by a signal transmitter 21 installed at a predetermined position on the track 2 or detects a rotation speed of the tire 11 to detect a position and speed of the vehicle 1. The speed/position sensor 14 outputs a signal indicating the detected position and speed to the monitoring device 13. The speed/position sensor 14 may detect the position or speed by using, for example, a satellite positioning system, or may detect the position or speed by using an image of the track 2 or surroundings.

In the following, “three axes” will be described as referring to each of “xyz axes”.

The acceleration sensor 17 detects the acceleration generated on a seating surface 16a of the seat 16 (three-axis acceleration in xyz-axis direction shown in FIG. 1) and outputs a signal indicating the detected acceleration to the monitoring device 13. The acceleration sensor 18 detects the acceleration generated on the floor 15 (three-axis acceleration in xyz-axis direction shown in FIG. 1) and outputs a signal indicating the detected acceleration to the monitoring device 13.

The number of acceleration sensors, the installation position, or the detection direction is not limited. For example, a single-axis acceleration sensor may be used, the number of acceleration sensors may be one or three or more, or the sensor may be installed at a plurality of locations on the floor 15 or set on a backrest of the seat 16 or the like. The acceleration sensor is not limited to translational or linear acceleration and may include a sensor that detects rotational vibration.

A person P1 is in the vehicle 1 in a state of being seated in the seat 16 (that is, in sitting position). A person P2 is in vehicle 1 in a state of standing on the floor 15 (that is, in standing position).

Next, the functional constituent elements included in the monitoring device 13 shown in FIG. 1 will be described with reference to FIG. 2. The monitoring device 13 shown in FIG. 1 has a computer (not shown) and peripheral devices such as an input/output device, a communication device, and a power supply device of the computer inside, and has the functional constituent elements shown in FIG. 2, which are composed of a combination of software such as a program executed by the computer and hardware including the computer and the peripheral devices. The monitoring device 13 shown in FIG. 2 has, as the functional constituent elements, an acceleration acquisition unit 31, an acceleration effective value acquisition unit 32, a corrected acceleration calculation unit 33, an abnormality detection unit 34, and a storage unit 35. The storage unit 35 stores a correction coefficient table 36, a speed range table 37, corrected acceleration 38, acceleration 39, and the like.

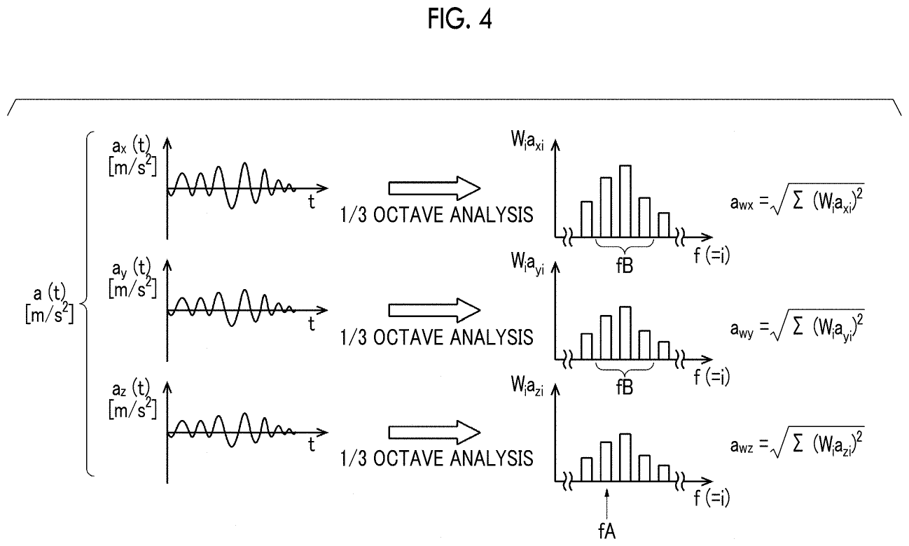

The acceleration acquisition unit 31 repeatedly acquires acceleration data (instantaneous value of acceleration) at a predetermined cycle from the acceleration sensors 17 and 18 mounted on the vehicle 1 traveling along the track 2. In the present embodiment, the acceleration acquisition unit 31 acquires acceleration data (time history data of acceleration) of three-axis components from the acceleration sensors 17 and 18. As shown in FIG. 4, the acceleration acquisition unit 31 acquires, for example, instantaneous values aₓ(t), a_{y}(t), and a_{z}(t) of the three-axis components of acceleration a(t) detected by the acceleration sensor 17 or 18. FIG. 4 is a schematic diagram for describing an operation example of the monitoring device 13 shown in FIG. 1. The acceleration acquisition unit 31 stores, for example, the time calendar data of the acceleration repeatedly acquired at a predetermined cycle from the acceleration sensors 17 and 18 for each station or for each predetermined section in the storage unit 35 as the acceleration 39. The section is a portion obtained by dividing the track 2 based on a distance, a position, or the like.

In the present embodiment, the “acceleration data” has been described as the data itself measured directly from the acceleration sensors 17 and 18 mounted on the vehicle 1, but is not limited to this aspect in another embodiment. In another embodiment, the “acceleration data” may be data calculated by differentiation or second-order differentiation from values measured by a displacement meter or a speedometer.

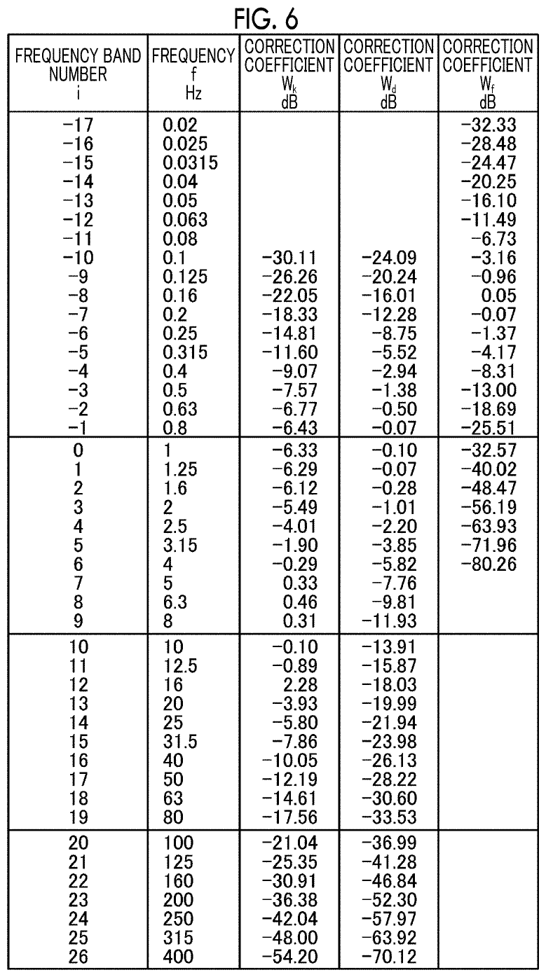

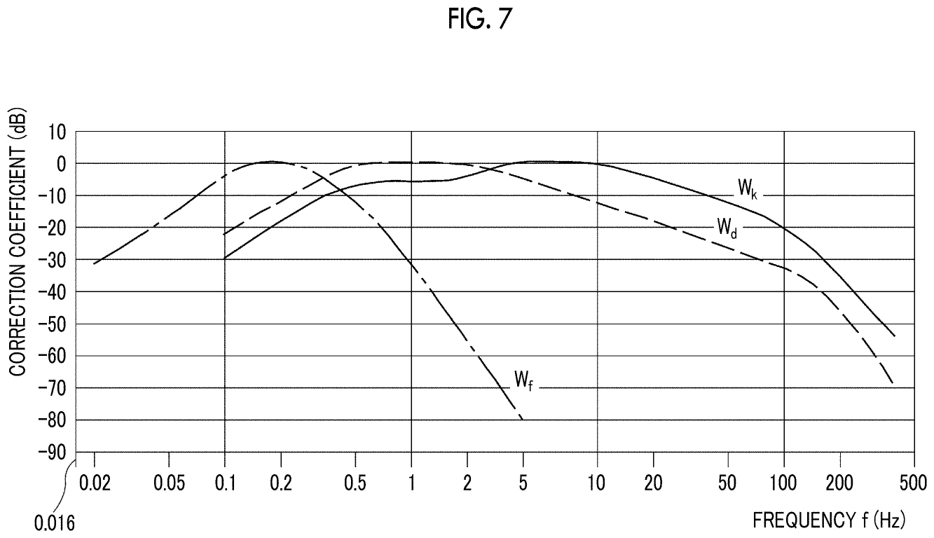

The acceleration effective value acquisition unit 32 acquires a plurality of acceleration effective values obtained by applying a bandpass filter for each of a plurality of constant ratio bandwidth, for example, for each of a plurality of 1/3 octave bands to the acceleration data acquired by the acceleration acquisition unit 31. In the present embodiment, the acceleration effective value acquisition unit 32 acquires the plurality of acceleration effective values (aₓᵢ, a_{yi}, and a_{zi} shown in FIG. 4) for each of the three-axis components, which are obtained by applying the bandpass filter for each constant ratio bandwidth to the acceleration data of the three-axis components acquired by the acceleration acquisition unit 31, for example. The aₓᵢ, a_{yi}, and a_{zi} shown in FIG. 4 are acceleration effective values in x-axis, y-axis, and z-axis directions of an i-th 1/3 octave band shown in FIG. 6. Frequency analysis can be classified into constant ratio bandwidth analysis and constant frequency width analysis depending on a bandwidth configuration of the bandpass filter used in the analysis. In the present embodiment, the constant ratio bandwidth analysis is used in the acceleration effective value acquisition unit 32. In the constant ratio bandwidth analysis in the acceleration effective value acquisition unit 32, a plurality of bandpass filters for each constant ratio bandwidth such as 1/1 octave band, 1/3 octave band, and 1/N octave band (N is a natural number) can be used. The constant ratio bandwidth analysis can be used, for example, in the frequency analysis for evaluating sensory quantity. The acceleration effective value acquisition unit measures (calculates) the acceleration of each band through the plurality of bandpass filters according to standards such as 1/1 octave and 1/3 octave. In the present embodiment, the acceleration effective value acquisition unit 32 acquires the acceleration effective value, for example, for each of 44 frequency bands (1/3 octave bands) obtained by dividing a frequency band of 0.02 to 400 Hz by a constant ratio, as shown in FIGS. 6 and 7. FIGS. 6 and 7 are diagrams showing basic correction coefficients described in Non-Patent Document 1. FIG. 6 shows a part of contents of “Table 3” of Non-Patent Document 1. FIG. 7 shows contents of “FIG. 2” of Non-Patent Document 1 (however, logarithmic scale on horizontal axis is partially changed). In FIG. 6, a frequency band number i is a band number according to International Electrotechnical Commission (IEC) 61260.

The corrected acceleration calculation unit 33 calculates an overall corrected acceleration effective value for each component (for each of x, y, and z components) using the following equation (9), based on each of the acceleration effective values (aₓᵢ, a_{yi}, and a_{zi} ) of each 1/3 octave band (each constant ratio bandwidth) and each correction coefficient (Wᵢ) determined in advance corresponding to each 1/3 octave band (each constant ratio bandwidth). The corrected acceleration calculation unit 33 calculates, for example, a_{wx}, a_{wy}, and a_{wz} shown in FIG. 4.

$${a}_{w} = {[ {\sum }_{i} {( {W}_{i} {a}_{i} )}^{2} ]}^{\frac{1}{2}} \qquad ( 9 )$$

Equation (9) is the same as equation (9) defined in Non-Patent Document 1. a_{w} is a corrected acceleration effective value (m/s²), and it is a formula that does not limit a direction (translational direction or rotational direction) corresponding to the corrected acceleration effective value a_{wx}. in the x-axis direction, the corrected acceleration effective value a_{wy}, in the y-axis direction, the corrected acceleration effective value a_{wz} in the z-axis direction, or the corrected acceleration effective value of the rotational vibration. aᵢ is the acceleration effective value of the i-th 1/3 octave band. The acceleration effective values aᵢ correspond to the acceleration effective values aₓᵢ, a_{yi}, and a_{zi} in the x-axis, y-axis, and z-axis directions. Wᵢ is, for example, an i-th correction coefficient of the 1/3 octave shown in FIG. 6. For example, the correction coefficient Wᵢ corresponds to a correction coefficient Wₖ, a correction coefficient W_{d}, and a correction coefficient W_{f} shown in FIG. 6. The correction coefficient Wk shown in FIG. 6 is the basic correction coefficient for health, comfort, and vibration perception, and is the correction coefficient for the z-axis direction (and vertical direction in supine position) in the standing and sitting positions. The correction coefficient W_{d} is the basic correction coefficient for health, comfort, and vibration perception, and is the correction coefficient for the x-axis and y-axis directions (and horizontal direction in supine position) in the standing and sitting positions. The correction coefficient W_{f} is the basic correction coefficient for vehicle sickness and is the correction coefficient for the z-axis direction in the standing and sitting positions. In Non-Patent Document 1, frequency range of an evaluation target for health, comfort, and vibration perception is 0.5 Hz to 80 Hz, and the frequency range of the evaluation target for vehicle sickness is 0.1 Hz to 0.5 Hz.

The corrected acceleration calculation unit 33 calculates the corrected acceleration effective value as a composite value of the three-axis components using the following equation (10), based on each acceleration effective value of each 1/3 octave band (each constant ratio bandwidth) for each of the three-axis components, each correction coefficient determined in advance corresponding to each 1/3 octave band (each constant ratio bandwidth), and a directional magnification for each of the three-axis components.

aᵥ=[kₓ²a_{wx}²+k_{y}²a_{wy}²+k_{z}²a_{wz}²]^{1/2} (10)

Equation (10) is the same as equation (10) defined in Non-Patent Document 1. aᵥ is a composite value of the three-axis components of the corrected acceleration effective value (also referred to as composite corrected value). kₓ, k_{y}, and k_{z} are directional magnifications (dimensionless magnifications) in the x, y, and z-axis directions. For example, regarding health, in the case of sitting position, the directional magnification kₓ of the correction coefficient W_{d} in the x-axis direction is 1.4, the directional magnification k_{y} of the correction coefficient W_{d} in the y-axis direction is 1.4, and the directional magnification k_{z} of the correction coefficient Wₖ in the z-axis direction is 1. For example, regarding comfort, in the cases of sitting and standing positions, the directional magnification kₓ of the correction coefficient W_{d} in the x-axis direction is 1, the directional magnification k_{y} of the correction coefficient W_{d} in the y-axis direction is 1, and the directional magnification k_{z} of the correction coefficient Wₖ in the z-axis direction is 1. For example, regarding vibration perception, the directional magnification kₓ in the x-axis direction is 1, the directional magnification k_{y} in the y-axis direction is 1, and the directional magnification k_{z} in the z-axis direction is 1.

In the present embodiment, the corrected acceleration effective value (also referred to as corrected acceleration) includes the corrected acceleration effective value a_{W} (corrected acceleration effective values a_{wx}, a_{wy}, and a_{wz}) and the composite corrected value aᵥ.

The abnormality detection unit 34 detects abnormality in the vehicle 1 or the track 2 based on the magnitude of the corrected acceleration effective value calculated by the corrected acceleration calculation unit 33. The abnormality detection unit 34 detects the abnormality in the vehicle 1 or the track 2 based on the magnitude of the composite value (composite corrected value) of the three-axis components of the corrected acceleration effective value. Alternatively, the abnormality detection unit 34 detects the abnormality in the vehicle 1 or the track 2 for each of the three-axis components based on the magnitude of the corrected acceleration effective value. The abnormality detection unit 34 can determine that the abnormality has occurred, for example, in a case where the corrected acceleration effective value exceeds a predetermined threshold value. The threshold value can be a value that can relatively distinguish between a normal case and an abnormal case. For example, the threshold value can be a value obtained by adding a certain margin to an actual value (maximum value, or the like) of the acceleration measured in the case of no abnormality, a calculated value in design, or the like.

In a case where the track 2 is divided into a plurality of sections, the abnormality detection unit 34 can detect the abnormality in the vehicle 1 or the track 2 based on the magnitude of the corrected acceleration for each section. The abnormality detection unit 34 may detect the abnormality in the vehicle 1 or the track 2 based on the magnitude of the corrected acceleration based on the acceleration data acquired in a case where a speed of the vehicle 1 is within a predetermined speed range. The abnormality detection unit can determine that there is the abnormality in the vehicle 1, for example, in a case where the abnormality is detected a plurality of times in the same vehicle 1 at different positions on the track 2. The abnormality detection unit 34 can determine that there is the abnormality in the track 2, for example, in a case where the abnormality is detected a plurality of times at the same position on the track 2 or the abnormality is detected at the same position on the track 2 in a plurality of different vehicles 1.

In the present embodiment, the abnormal state detection unit 34 has a function of acquiring data such as the position, the speed, and the like used for the determination in the abnormal state detection unit 34, a function of determining whether or not the speed and the like satisfy the conditions for determining the abnormal state, and the like.

As shown in FIG. 6, the correction coefficient table 36 stored in the storage unit 35 is a table in which a plurality of correction coefficients of one or a plurality of types defined to be suitable for evaluating the health, comfort, vibration perception, or vehicle sickness of the person in the vehicle are defined for each 1/3 octave band (constant ratio bandwidth). For example, the correction coefficient table 36 may be defined as a function having a value of the frequency band shown in FIG. 6 as a variable or may be included in a function for calculating the corrected acceleration effective value (corrected acceleration) (as part of program representing function).

The speed range table 37 is a table that associates the position (section) on the track 2 with a speed range of the vehicle 1 during normal traveling.

The corrected acceleration 38 is a file (data) including an actual value of a past corrected acceleration effective value calculated by the corrected acceleration calculation unit 33 of the vehicle 1 or another vehicle 1. The actual value of the corrected acceleration effective value is stored in the storage unit 35 as the corrected acceleration 38 in association with, for example, an acquisition date and time, an acquisition position, a speed at the time of acquisition, and a weight of the vehicle 1 (or passenger) at the time of acquisition. For example, the weight of the vehicle 1 (or passenger) at the time of acquisition can be calculated based on a measurement result of a load (distortion) applied to the tires 11 and 12 or can be estimated based on dynamic characteristics of a power source (motor, or the like) during acceleration/deceleration.

The acceleration 39 is a file (data) including the latest acceleration data for a predetermined time output by the acceleration sensors 17 and 18. The acceleration data is stored in the storage unit 35 as the acceleration 39 in association with, for example, the acquisition date and time.

(Operation Example of Monitoring Device)

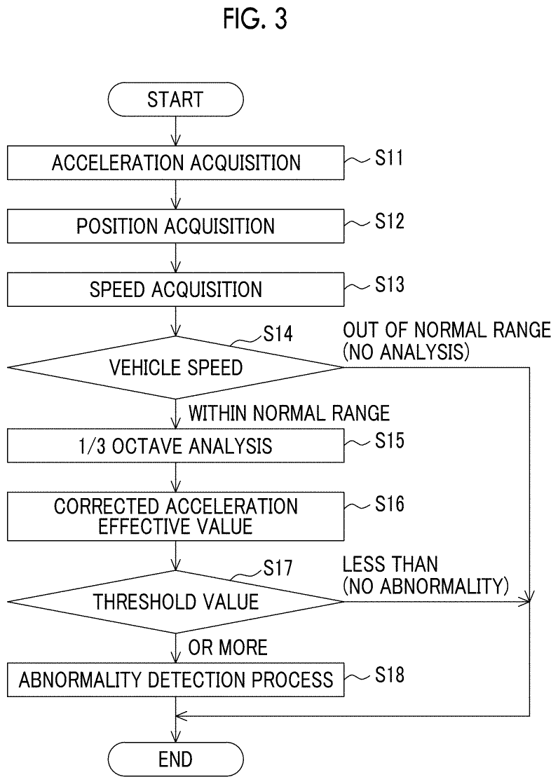

Next, an operation example of the monitoring device 13 described with reference to FIGS. 1 and 2 will be described with reference to FIG. 3. FIG. 3 is a flowchart showing the operation example of the monitoring device 13 shown in FIGS. 1 and 2. A process shown in FIG. 3 is repeatedly executed, for example, for each station or for each predetermined section while the vehicle 1 is in operation.

When the process shown in FIG. 3 is started, the abnormal state detection unit 34 shown in FIG. 2 acquires the latest time calendar data for each station or for each predetermined section of the three-axis components of the acceleration data detected by the acceleration sensors 17 and 18 from the storage unit 35 (acceleration 39) (step S11). Next, the abnormal state detection unit 34 acquires, from the speed/position sensor 14, position information (step S12) and speed information (step S13).

Next, the abnormal state detection unit 34 refers to the speed range table 37 based on the position information acquired in step S12 to determine whether or not the vehicle speed acquired in step S13 is within a normal range (step S14).

In a case where the abnormal state detection unit 34 determines in step S14 that the vehicle speed is not within the normal range, the abnormal state detection unit 34 ends the process shown in FIG. 3.

On the other hand, in a case where the abnormal state detection unit 34 determines in step S14 that the vehicle speed is within the normal range, the acceleration effective value acquisition unit 32 and the corrected acceleration calculation unit 33 execute 1/3 octave analysis (step S15). In step S15, the acceleration effective value acquisition unit 32 acquires the acceleration effective value for each band by applying the bandpass filter for each of the plurality of 1/3 octave bands to the acceleration data (time calendar data) of the acceleration data, which is acquired by the acceleration acquisition unit 31 and stored in the storage unit 35, acquired by the abnormal state detection unit 34 from the storage unit 35. In step S15, the corrected acceleration calculation unit 33 calculates the corrected acceleration effective value as the composite value of the three-axis components using equation (10) based on each acceleration effective value of each 1/3 octave band for each of the three-axis components, each correction coefficient determined in advance corresponding to each 1/3 octave band, and the directional magnification for each of the three-axis components. Alternatively, in step S15, the corrected acceleration calculation unit 33 calculates the overall corrected acceleration effective value for each component (for each of x, y, and z components) using the following equation (9), based on each acceleration effective value of each 1/3 octave band and each correction coefficient determined in advance corresponding to each 1/3 octave band.

Next, the abnormal state detection unit 34 refers to the corrected acceleration effective value calculated in step S15 (step S16) to compare the corrected acceleration effective value with a predetermined threshold value (step S17). In step S17, the abnormal state detection unit 34 compares, for each acceleration sensor, the composite corrected value aᵥ calculated in step S15 with the threshold value determined in advance. Alternatively, in step S17, the abnormal state detection unit 34 compares, for each acceleration sensor, the corrected acceleration effective value a_{wx} in the x-axis direction, the corrected acceleration effective value a_{wy} in the y-axis direction, and the corrected acceleration effective value a_{wz} in the z-axis direction calculated in step S15 with each threshold value determined in advance for each axial direction.

In a case where the corrected acceleration effective values a_{wx}, a_{wy}, and a_{wz} and the composite corrected value aᵥ are all less than each of the threshold values in step S17, the abnormal state detection unit 34 ends the process shown in FIG. 3, assuming that there is no abnormality.

On the other hand, in a case where at least one of the corrected acceleration effective values a_{wx}, a_{wy}, and a_{wz} or the composite corrected value aᵥ is equal to or greater than the corresponding threshold value in step S17, the abnormal state detection unit 34 executes an abnormality detection process, assuming that there is the abnormality (step S18). The abnormality detection process in step S18 is a process to be executed in a case where the abnormal state detection unit 34 detects the abnormality and includes a process of making a notification that the abnormality is detected, recording the detection of the abnormality, or analyzing contents of the abnormality, for example. For example, as the notification that the abnormality is detected, the abnormal state detection unit 34 outputs a predetermined signal using a monitor or audio device included in the monitoring device 13 or transmits predetermined information to a terminal or the like outside the monitoring device 13. As the record of the detection of the abnormality, the abnormal state detection unit 34 records the fact in the storage unit 35 or records the fact in an external server or the like.

The analysis of the contents of the abnormality performed by the abnormal state detection unit 34 includes, for example, the following. That is, the abnormal state detection unit 34 discriminates, for example, as the abnormality on the track 2 in a case where it is discriminated that the abnormality is in the same section (position) in a plurality of vehicles and as the abnormality in the vehicle 1 in a case where it is discriminated that the abnormality is only in one vehicle 1. For example, in a case where the track 2 is discriminated to be abnormal, the abnormal state detection unit 34 determines whether a road surface is bad or a guide rail is bad, depending on which of a vertical direction and a horizontal direction is discriminated to be abnormal. In a case where the vehicle is discriminated to be abnormal, the abnormal state detection unit 34 can also discriminate whether there is the abnormality in, for example, a tire or an air spring in the case of the vertical direction or there is the abnormality in a guide wheel that is pressed against the guide rail or the like in the case of the horizontal direction.

(Action and Effect of First Embodiment)

As described above, according to the present embodiment, with the analysis of the acceleration of the vehicle structure or the like using the acceleration sensor mounted on the vehicle, it is possible to monitor whether there is a section or a vehicle that makes a passenger uncomfortable (bad in ride quality due to acceleration).

In the present embodiment, the acceleration data acquired in time history is analyzed according to, for example, ISO2631-1: 1997 (JIS B 7760-2: 2004), and the corrected acceleration effective value in the three-axis direction or the composite corrected value obtained by combining the acceleration in the three-axis direction is calculated. When the analysis is performed according to the ISO, the acceleration value for each 1/3 octave band is used. Therefore, the acceleration of the frequency component that does not contribute to the ride quality due to influence of noise of an accelerometer or the like is not taken into consideration. However, instead of ISO2631-1: 1997 (JIS B 7760-2: 2004), the process may be performed by using a filter and a correction coefficient that increases a weight of a low frequency component having a high contribution to the ride quality and decreases a weight of a high frequency component having a low contribution to the ride quality.

Regarding the acceleration used in the analysis, in a case where the corrected acceleration effective value for each direction is used for the analysis instead of the composite corrected value in the three-axis direction, in a case where the track 2 is discriminated to be abnormal, it is possible to determine whether the road surface is bad or the guide rail is bad, depending on which of the vertical direction and the horizontal direction is discriminated to be abnormal. In a case where the vehicle 1 is discriminated to be abnormal, it is also possible to discriminate whether there is the abnormality in the tire, the air spring, or the like in the case of the vertical direction, or there is the abnormality in the guide wheel that is pressed against the guide rail or the like in the case of the horizontal direction.

For example, in AGT, the vehicle 1 travels on the track 2 at the same speed each time. In the present embodiment, the influence of a difference in generated acceleration due to a difference in a speed, such as a case where traveling in different driving modes or having a difference in an average speed with a certain threshold value or more is performed, is not taken into consideration. Therefore, in a case where the average speed of a section to be analyzed deviates from the threshold value, no acceleration analysis is performed.

As described above, according to the present embodiment, the filter process is performed to the time history data of the acceleration such that the component having a high contribution to the ride quality becomes main and then the evaluation is performed. Therefore, it is possible to appropriately monitor whether there is any deterioration in the ride quality or the like. According to the present embodiment, it is possible to appropriately determine whether or not abnormal vibration is generated for a person in a vehicle.

### Second Embodiment

In the monitoring device 13 of the first embodiment, the abnormality detection unit 34 detects the presence or absence of the abnormality based on the overall corrected acceleration effective value (composite corrected value aᵥ or corrected acceleration effective value a_{w} (corrected acceleration effective values a_{wx}, a_{wy}, and a_{wz})). On the contrary, in the monitoring device 13 of a second embodiment, the abnormality detection unit 34 detects the presence or absence of the abnormality based on a specific frequency (1/3 octave band) component. Regarding the configuration and operation of the first and second embodiments, some operations of the corrected acceleration calculation unit 33 and the abnormality detection unit 34 are different, and the points will be described below.

In the second embodiment, the corrected acceleration calculation unit 33 calculates each piece of corrected acceleration for each type based on each acceleration effective value of one or a plurality of 1/3 octave bands (constant ratio bandwidth) of a plurality of types and each correction coefficient determined in advance corresponding to each 1/3 octave band (constant ratio bandwidth). The abnormality detection unit 34 detects the abnormality in the vehicle 1 or the track 2 based on the magnitude of each piece of corrected acceleration for each type. As shown in FIG. 4, the one or the plurality of 1/3 octave bands of the plurality of types are, for example, a frequency band classified by different directions and frequency bands, such as one band (fA) in the z-axis direction (referred to as type A) and three bands (fB) in each direction of the x-axis and y-axis directions (referred to as type B). The abnormality detection unit 34 evaluates only vertical vibration of the vehicle structure or a band close to a pitching frequency, for example, to determine whether or not the abnormality has occurred in the air spring of the vehicle, which has a high contribution to ride quality.

(Action and Effect of Second Embodiment)

According to the second embodiment, an analysis parameter increases, but it is possible to narrow down a factor of the abnormality by, for example, performing axial analysis.

### Third Embodiment

In the monitoring device 13 of a third embodiment, the abnormality detection unit 34 detects the abnormality in the vehicle 1 or the track 2 based on a Mahalanobis distance from a unit space in which a plurality of the pieces of corrected acceleration (composite corrected value aᵥ or corrected acceleration effective values a_{wx}, a_{wy}, and a_{wz}) calculated in the past are used as one parameter. Regarding the configuration and operation of the third embodiment and the first and second embodiments, some operations of the abnormality detection unit 34 are different, and the points will be described below.

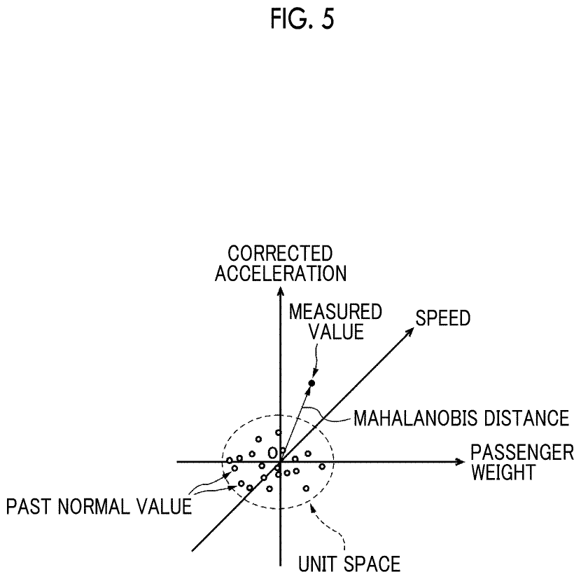

Since the acceleration generated in the vehicle 1 differs depending on, for example, a vehicle speed or a weight, it may be desirable to set a different threshold value as a reference for determining the abnormality according to the speed or a passenger weight. However, for example, it is troublesome to set the acceleration threshold value for each passenger weight or speed. In the third embodiment, the abnormality detection unit 34 determines the presence or absence of the abnormality, for example, by learning data by an MT method (Mahalanobis Taguchi method) or the like for each section with the passenger weight, the speed, and the corrected acceleration (composite acceleration value or the like) as parameters and comparing the Mahalanobis distance from the unit space of each piece of data with a predetermined threshold value. FIG. 5 is a schematic diagram for describing the operation example of the monitoring device 13 shown in FIG. 1, and shows an example of distribution of the passenger weight, the speed, and the corrected acceleration. Each axis represents a normalized value (value obtained by dividing difference from average value by standard deviation) of the passenger weight, the speed, and the corrected acceleration. The unit space is a space occupied by normal data (reference data). In this case, the Mahalanobis distance from the unit space of the measured value of the evaluation target can be represented by a distance from the origin O.

The learning data is added as the normal data only in a case where it is clear from an inspection or the like that there is no abnormality in the vehicle/track. The abnormality detection unit 34 discriminates whether newly acquired data is abnormal (Mahalanobis distance is equal to or greater than threshold value). The threshold value is set to, for example, about 3 to 4. When the distance is equal to or greater than the threshold value, it is regarded as abnormal. The passenger weight, the speed, the acceleration effective value, and the composite acceleration value may be applied as the parameters by using the acceleration effective value of the specific band described in the second embodiment. The parameters may be, for example, two of the passenger weight and the corrected acceleration, or two of the speed and the corrected acceleration.

(Action and Effect of Third Embodiment)

According to the third embodiment, even when the threshold value of the acceleration abnormality is not set, it is possible to determine the presence or absence of the occurrence of the abnormality by only evaluating whether the difference is larger than that of the normal data (data acquired so far).

(Actions and Effects of First, Second, and Third Embodiments)

According to the first, second, and third embodiments, for example, only the data with the traveling speed that satisfies the condition determined in advance is used in order to monitor whether or not the acceleration having an adverse effect on the ride quality is generated. Therefore, it is possible to perform the abnormality discrimination by excluding a factor that causes the acceleration fluctuation due to a factor other than the track or vehicle abnormality.

### Another Embodiment

Although the embodiments of the present disclosure have been described in detail with reference to the drawings, the specific configuration is not limited to the embodiments and includes a design change and the like within a range not departing from the gist of the present disclosure. For example, instead of limiting the determination target of the abnormal state to the case where the traveling speed is within the predetermined range (or in addition to that), the determination target may be limited to a case where the passenger weight is within a predetermined range.

<Computer Configuration>

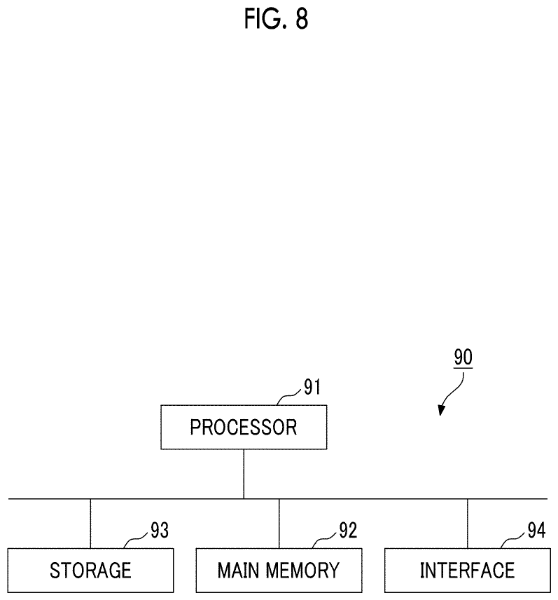

FIG. 8 is a schematic block diagram showing a configuration of a computer according to at least one embodiment.

A computer 90 includes a processor 91, a main memory 92, a storage 93, and an interface 94.

The monitoring device 13 described above is mounted on the computer 90. An operation of each processing unit described above is stored in the storage 93 in the form of a program. The processor 91 reads out the program from the storage 93, expands the program in the main memory 92, and executes the above processing according to the program. The processor 91 ensures a storage area corresponding to each storage unit described above in the main memory 92 according to the program.

The program may be intended to realize some of the functions performed by the computer 90. For example, the program may perform the function in combination with another program already stored in the storage or in combination with another program mounted on another device. In another embodiment, the computer may include a custom large scale integrated circuit (LSI) such as a programmable logic device (PLD) in addition to or in place of the above configuration. Examples of the PLD include a programmable array logic (PAL), a generic array logic (GAL), a complex programmable logic device (CPLD), and a field programmable gate array (FPGA). In this case, some or all of the functions realized by the processor may be realized by the integrated circuit.

Examples of the storage 93 include a hard disk drive (HDD), a solid state drive (SSD), a magnetic disk, an optical magnetic disk, a compact disc read only memory (CD-ROM), a digital versatile disc read only memory (DVD-ROM), and a semiconductor memory. The storage 93 may be an internal medium directly connected to a bus of the computer 90 or may be an external medium connected to the computer 90 through the interface 94 or a communication line. In a case where the program is distributed to the computer 90 through the communication line, the computer 90 that receives the distribution may expand the program into the main memory 92 and execute the above processing. In at least one embodiment, the storage 93 is a non-transitory tangible storage medium.

<Additional Notes>The monitoring device 13 described in each embodiment is grasped as follows, for example.

(1) A monitoring device 13 according to a first aspect includes an acceleration acquisition unit 31 that acquires acceleration data of a vehicle 1 traveling along a track 2, an acceleration effective value acquisition unit 32 that acquires a plurality of acceleration effective values obtained by applying a bandpass filter for each of a plurality of constant ratio bandwidths to the acceleration data, a corrected acceleration calculation unit 33 that calculates corrected acceleration based on each acceleration effective value of each of the constant ratio bandwidths and each correction coefficient determined in advance corresponding to each of the constant ratio bandwidths, and an abnormality detection unit 34 that detects abnormality in the vehicle 1 or the track 2 based on magnitude of the corrected acceleration.

According to this configuration, it is possible to appropriately determine whether or not abnormal vibration is generated for persons P1 and P2 in the vehicle 1.

(2) The monitoring device 13 according to a second aspect is the monitoring device 13 of (1), in which each correction coefficient is defined to be suitable for evaluating comfort or vehicle sickness of persons P1 and P2 in the vehicle 1.

(3) The monitoring device 13 according to a third aspect is the monitoring device 13 of (1) or (2), in which the acceleration acquisition unit 31 acquires the acceleration data for each of three-axis components, the acceleration effective value acquisition unit 32 acquires, for each of the three-axis components, a plurality of the acceleration effective values obtained by applying the bandpass filter for each of the constant ratio bandwidths to the acceleration data of the three-axis components, and the corrected acceleration calculation unit 33 calculates the corrected acceleration as a composite value of the three-axis components based on each acceleration effective value of each constant ratio bandwidth for each of the three-axis components, each correction coefficient determined in advance corresponding to each constant ratio bandwidth, and a directional magnification for each of the three-axis components.

According to this configuration, it is possible to appropriately determine whether or not the abnormal vibration is generated for the persons P1 and P2 in the vehicle 1 based on the composite value of the three-axis components.

(4) The monitoring device 13 according to a fourth aspect is the monitoring device 13 of (1) or (2), in which the acceleration acquisition unit 31 acquires the acceleration data for each of three-axis components, the acceleration effective value acquisition unit 32 acquires, for each of the three-axis components, a plurality of the acceleration effective values obtained by applying the bandpass filter for each of the constant ratio bandwidths to the acceleration data of the three-axis components, the corrected acceleration calculation unit 33 calculates the corrected acceleration for each of the three-axis components based on each acceleration effective value of each of the constant ratio bandwidths for each of the three-axis components and each correction coefficient determined in advance corresponding to each of the constant ratio bandwidths, and the abnormality detection unit 34 detects abnormality in the vehicle or the track for each of the three-axis components based on the magnitude of the corrected acceleration.

According to this configuration, it is possible to appropriately determine whether or not the abnormal vibration is generated for the persons P1 and P2 in the vehicle 1 based on each component of the three axes.

(5) The monitoring device 13 according to a fifth aspect is the monitoring device 13 of any one of (1) to (4), in which the track 2 is divided into a plurality of sections, and the abnormality detection unit 34 detects abnormality in the vehicle or the track based on the magnitude of the corrected acceleration for each section.

(6) The monitoring device 13 according to a sixth aspect is the monitoring device 13 of any one of (1) to (5), in which the abnormality detection unit 34 detects abnormality in the vehicle 1 or the track 2 based on the magnitude of the corrected acceleration based on the acceleration data acquired in a case where a speed of the vehicle 1 is within a predetermined speed range (in case of “within normal range” in step S14).

According to this configuration, it becomes easy to avoid erroneous detection of the presence or absence of the abnormal state.

(7) The monitoring device 13 according to a seventh aspect is the monitoring device 13 of any one of (1) to (6), in which the corrected acceleration calculation unit 33 calculates each piece of corrected acceleration for each type based on each of the acceleration effective values of one or a plurality of constant ratio bandwidths of a plurality of types and each of the correction coefficients determined in advance corresponding to each of the constant ratio bandwidths, and the abnormality detection unit 34 detects abnormality in the vehicle or the track based on the magnitude of each piece of corrected acceleration for each type.

According to this configuration, it is possible to analyze the abnormal state in more detail.

(8) The monitoring device 13 according to an eighth aspect is the monitoring device 13 of any one of (1) to (7), in which the abnormality detection unit 34 detects abnormality in the vehicle 1 or the track 2 based on a Mahalanobis distance from a unit space having a plurality of pieces of corrected acceleration calculated in the past as one parameter.

According to this configuration, it is possible to set a reference for determining the presence or absence of the abnormal state without any trouble.

### INDUSTRIAL APPLICABILITY

According to the verification processing device, update processing method, and program described above, it is possible to suppress a human error while shortening a work time.

### REFERENCE SIGNS LIST

1: vehicle

2: track

11, 12: tire

13: monitoring device

14: speed/position sensor

15: floor

16: seat

17, 18: acceleration sensor

P1, P2: person

31: acceleration acquisition unit

32: acceleration effective value acquisition unit

33: corrected acceleration calculation unit

34: abnormality detection unit

35: storage unit

36: correction coefficient table

37: speed range table

38: corrected acceleration

39: acceleration

1. A monitoring device comprising:
an acceleration acquisition unit that acquires acceleration data of a vehicle traveling along a track;
an acceleration effective value acquisition unit that acquires a plurality of acceleration effective values obtained by applying a bandpass filter for each of a plurality of constant ratio bandwidths to the acceleration data;
a corrected acceleration calculation unit that calculates corrected acceleration based on each acceleration effective value of each of the constant ratio bandwidths and each correction coefficient determined in advance corresponding to each of the constant ratio bandwidths; and
an abnormality detection unit that detects abnormality in the vehicle or the track based on magnitude of the corrected acceleration.

2. The monitoring device according to claim 1,
wherein each correction coefficient is defined to be suitable for evaluating comfort or vehicle sickness of a person in the vehicle.

3. The monitoring device according to claim 1,
wherein the acceleration acquisition unit acquires the acceleration data for each of three-axis components,
the acceleration effective value acquisition unit acquires, for each of the three-axis components, a plurality of the acceleration effective values obtained by applying the bandpass filter for each of the constant ratio bandwidths to the acceleration data of the three-axis components, and
the corrected acceleration calculation unit calculates the corrected acceleration as a composite value of the three-axis components based on each acceleration effective value of each constant ratio bandwidth for each of the three-axis components, each correction coefficient determined in advance corresponding to each constant ratio bandwidth, and a directional magnification for each of the three-axis components.

4. The monitoring device according to claim 1,
wherein the acceleration acquisition unit acquires the acceleration data for each of three-axis components,
the acceleration effective value acquisition unit acquires, for each of the three-axis components, a plurality of the acceleration effective values obtained by applying the bandpass filter for each of the constant ratio bandwidths to the acceleration data of the three-axis components,
the corrected acceleration calculation unit calculates the corrected acceleration for each of the three-axis components based on each acceleration effective value of each of the constant ratio bandwidths for each of the three-axis components and each correction coefficient determined in advance corresponding to each of the constant ratio bandwidths, and
the abnormality detection unit detects abnormality in the vehicle or the track for each of the three-axis components based on the magnitude of the corrected acceleration.

5. The monitoring device according to claim 1,
wherein the track is divided into a plurality of sections, and
the abnormality detection unit detects abnormality in the vehicle or the track based on the magnitude of the corrected acceleration for each section.

6. The monitoring device according to claim 1,
wherein the abnormality detection unit detects abnormality in the vehicle or the track based on the magnitude of the corrected acceleration based on the acceleration data acquired in a case where a speed of the vehicle is within a predetermined speed range.

7. The monitoring device according to any one of claims 1 to 6claim 1,
wherein the corrected acceleration calculation unit calculates each piece of corrected acceleration for each type based on each of the acceleration effective values of one or a plurality of constant ratio bandwidths of a plurality of types and each of the correction coefficients determined in advance corresponding to each of the constant ratio bandwidths, and
the abnormality detection unit detects abnormality in the vehicle or the track based on the magnitude of each piece of corrected acceleration for each type.

8. The monitoring device according to claim 1,
wherein the abnormality detection unit detects abnormality in the vehicle or the track based on a Mahalanobis distance from a unit space having a plurality of pieces of corrected acceleration calculated in the past as one parameter.

9. A monitoring method comprising:
a step of acquiring acceleration data of a vehicle traveling along a track;
a step of acquiring a plurality of acceleration effective values obtained by applying a bandpass filter for each of a plurality of constant ratio bandwidths to the acceleration data;
a step of calculating corrected acceleration based on each acceleration effective value of each of the constant ratio bandwidths and each correction coefficient determined in advance corresponding to each of the constant ratio bandwidths; and
a step of detecting abnormality in the vehicle or the track based on magnitude of the corrected acceleration.

10. A computer-readable storage medium storing a program for causing a computer to execute:
a step of acquiring acceleration data of a vehicle traveling along a track;
a step of acquiring a plurality of acceleration effective values obtained by applying a bandpass filter for each of a plurality of constant ratio bandwidths to the acceleration data;
a step of calculating corrected acceleration based on each acceleration effective value of each of the constant ratio bandwidths and each correction coefficient determined in advance corresponding to each of the constant ratio bandwidths; and
a step of detecting abnormality in the vehicle or the track based on magnitude of the corrected acceleration.
